(19) United States
(12) Patent Application Publication
(10) Pub. No.: US 2013/0265898 A1
(43) Pub. Date: Oct. 10, 2013

(54) APPARATUS AND METHOD FOR ALLOCATING RESOURCE FOR AVOIDING INTERFERENCE OF WIRELESS COMMUNICATION SYSTEM

(71) Applicant: ELECTRONICS AND TELECOMMUNICATIONS RESEARCH INSTITUTE, (US)

(72) Inventors: Wooram SHIN, Daejeon (KR); Hyun-jae KIM, Incheon (KR); Jihyung KIM, Daejeon (KR); Anseok LEE, Daejeon (KR); Kwang Jae LIM, Daejeon (KR); DongSeung KWON, Daejeon (KR)

(73) Assignee: ELECTRONICS AND TELECOMMUNICATIONS RESEARCH INSTITUTE, Daejeon (KR)

(21) Appl. No.: 13/851,570

(22) Filed: Mar. 27, 2013

(30) Foreign Application Priority Data
Mar. 30, 2012 (KR) 10-2012-0033381

(51) Int. Cl. H04W 72/08

(52) U.S. Cl. CPC H04W 72/082
USPC 370/252; 370/329; 370/330

(57) ABSTRACT

In a wireless communication system, a transmitting node selects a simultaneously transmit-unavailable node of a 1-hop node of the transmitting node, and allocates a transmitting resource in transmissible resources, except for a transmission scheduled resource of a simultaneously transmit-unavailable node. Further, a receiving node selects a simultaneously receive-unavailable node of a 1-hop node, which is a transmission target of the receiving node selects a simultaneously transmit-unavailable node of a 1-hop node of the receiving node, and allocates a receiving resource in receivable resources, except for a transmission scheduled resource to a simultaneously transmit-unavailable node of a simultaneously receive-unavailable node of the 1-hop node, which is a transmission target of the receiving node.

### CROSS-REFERENCE TO RELATED APPLICATION

This application claims priority to and the benefit of Korean Patent Application No. 10-2012-0033381 filed in the Korean Intellectual Property Office on Mar. 30, 2012, the entire contents of which are incorporated herein by reference.

### BACKGROUND OF THE INVENTION

(a) Field of the Invention

The present invention relates to a method and apparatus for allocating a resource for avoiding interference of a wireless communication system. More particularly, the present invention relates to a method and apparatus for allocating a resource that can avoid interference by a time or frequency offset that may occur due to imperfect synchronization in a wireless communication system.

(b) Description of the Related Art

In a wireless communication system such as a wireless mesh network in which a center concentrative control is difficult, unlike a cellular network, each node dispersively allocates a resource.

In general, in a cellular network, a base station is fixed, and in a downlink, the base station transmits a signal with fixed power. Therefore, because terminals that are positioned at a cell boundary have similar reception power from each base station, even if an offset exists in synchronization with base stations, the offset does not operate as large interference. In the cellular network, because a terminal that is positioned at a cell center has relatively small reception power from each base station, except for a serving base station, even if synchronization is acquired from base stations, it does not operate as large interference. In an uplink of the cellular network, because reception power from a terminal that is positioned at a cell center is larger than reception power from a terminal that is positioned at a cell boundary, even if terminals simultaneously receive signals from different resources, due to imperfect synchronization, a signal from a terminal that is positioned at a cell boundary is affected by inter-carrier interference (ICI) or inter-symbol interference (ISI) that is generated by a signal from a terminal that is positioned at a cell center and thus may not be received. However, a terminal that is positioned at a cell center reduces a difference between reception power from the terminal that is positioned at a cell center and reception power from a terminal that is positioned at a cell boundary by reducing transmission power using uplink power control, thereby overcoming an influence of interference due to imperfect synchronization of two terminals.

Unlike such a cellular network, in a wireless mesh network, a distance between a node B and a node C may be smaller than that between the node B and a node A, as shown in FIG. 1. In general, as a distance between a transmitting node and a receiving node is smaller, signal intensity increases, but an opposite case may occur by shadowing or fading. In this case, when the node B transmits a signal of a relative large power to the node A, in the node C, reception power from the node B becomes considerably larger than reception power from the node D. When the node B transmits a signal to the node A, if the node C receives a signal of the node D, in the node C, due to imperfect synchronization of the node D and the node B, even if a time or frequency offset of the node B occurs as a small value, reception power from the node B is very much larger than reception power from the node D and thus an influence of interference (ISI or ICI) by an offset may also be considerably large.

That is, even if a transmitting resource of the node B and a transmitting resource of the node D are different at the same transmission segment, when synchronization of the node C and the node B and synchronization of the node C and the node D deviates, and when reception power from the node B is larger by at least a reference value than reception power from the node D, a power level of interference (ISI or ICI) by an offset with the node B reduces a signal to interference-plus-noise ratio (SINR) of a received signal from the node D and thus a receiving failure may occur. Therefore, in a wireless mesh network, a resource allocation method for avoiding interference that may occur due to imperfect synchronization with adjacent nodes is requested.

### SUMMARY OF THE INVENTION

The present invention has been made in an effort to provide a method and apparatus for allocating a resource for avoiding interference of a wireless communication system having advantages of preventing a receiving failure by interference that may occur due to imperfect synchronization with adjacent nodes in a wireless mesh network.

An exemplary embodiment of the present invention provides a method in which a transmitting node allocates a resource for avoiding interference in a wireless communication system. The method includes: selecting simultaneously transmit-unavailable nodes of the 1-hop nodes of the transmitting node among 1-hop nodes of the transmitting node; acquiring transmission scheduled resources of 1-hop nodes of the transmitting node and 1-hop nodes of 1-hop nodes of the transmitting node; excluding a transmission scheduled resource of simultaneously transmit-unavailable nodes of a 1-hop node of the transmitting node from transmissible resources of the transmitting node; and allocating a transmitting resource in the transmissible resources.

The selecting may include: calculating values that are differences between a channel quality value of each 1-hop node of the 1-hop node of the transmitting node and channel quality values of the 1-hop nodes of the transmitting node or values that are quotients of channel quality values of the 1-hop nodes of the transmitting node and a channel quality value of each 1-hop node of the 1-hop nodes of the transmitting node; and selecting a 1-hop node of a 1-hop node of a transmitting node in which the subtracted value or the divided value is larger than a reference value as a simultaneously transmit-unavailable node of the 1-hop nodes of the transmitting node.

The calculating may include: measuring channel quality values of the 1-hop nodes of the transmitting node; and receiving channel quality values of the 1-hop nodes of the 1-hop nodes of the transmitting node from the 1-hop nodes of the transmitting node.

The calculating may further include: receiving reference signals from the 1-hop nodes of the transmitting node; and measuring channel quality values of the 1-hop nodes of the transmitting node from the reference signals.

The resource may include subframes of a time axis and subchannels of a frequency axis, and the excluding of a transmission scheduled resource may include excluding a subframe including a subchannel corresponding to a transmission scheduled resource of the simultaneously transmit-unavailable node from transmissible resources of the transmitting node.

Another embodiment of the present invention provides a method in which a receiving node allocates a resource for avoiding interference in a wireless communication system. The method includes: selecting a simultaneously transmit-unavailable node of each 1-hop node of the receiving node among 1-hop nodes of the receiving node; selecting a simultaneously receive-unavailable node of each 1-hop node of the receiving node among the 1-hop nodes of the receiving node; acquiring transmission scheduled resources of the 1-hop nodes of the receiving node; excluding a transmission scheduled resource to a simultaneously transmit-unavailable node of a simultaneously receive-unavailable node of the 1-hop nodes, which is a transmission target of the receiving node, from receivable resources of the receiving node; and allocating a receiving resource in the receivable resources.

The selecting of a simultaneously transmit-unavailable node may include: calculating values that are differences between a channel quality value of another 1-hop node and a channel quality values of the 1-hop nodes of each 1-hop node of the transmitting node or values that are quotients of channel quality values of the 1-hop nodes of each 1-hop node of the receiving node and channel quality values of another 1-hop nodes; and selecting, if the difference values or the quotient values is larger than a reference value, the other 1-hop node of the 1-hop node as a simultaneously receive-unavailable node.

The calculating may include: receiving reference signals from the 1-hop nodes of the receiving node; and measuring channel quality values of the 1-hop nodes of the receiving node from the reference signals.

The selecting of a simultaneously transmit-unavailable node may include: calculating values that are differences between a channel quality value of each 1-hop node of the 1-hop nodes of the receiving node and channel quality values of the 1-hop nodes of the receiving node or values that are quotients of channel quality values of the 1-hop nodes of the receiving node and a channel quality value of each 1-hop node of the 1-hop nodes of the receiving node; and selecting a 1-hop node of a 1-hop node of a receiving node in which the difference values or the quotient values is larger than a reference value as a simultaneously transmit-unavailable node of the 1-hop nodes of the receiving node.

The calculating may include: receiving, by 1-hop nodes of the receiving node, reference signals of the 1-hop nodes of the 1-hop nodes of the receiving node; measuring, by the 1-hop nodes of the receiving node, channel quality values of the 1-hop nodes of the 1-hop node of the receiving node from the reference signals; and receiving channel quality values of the 1-hop nodes of the 1-hop nodes of the receiving node in which the 1-hop nodes of the receiving node measures.

The resource may include subframes of a time axis and subchannels of a frequency axis, and the excluding of a transmission scheduled resource may include excluding a subframe including a subchannel corresponding to a transmission scheduled resource to a simultaneously transmit-unavailable node of the simultaneously receive-unavailable node from the receivable resource of the receiving node.

Yet another embodiment of the present invention provides an apparatus that allocates a resource for avoiding interference in a node of a wireless communication system. The resource allocation apparatus includes a receiver and an allocation controller. The receiver receive control messages from 1-hop nodes of the node. The allocation controller acquire transmission scheduled resources of 1-hop nodes of the 1-hop nodes and transmission scheduled resources of the 1-hop nodes through the control messages, selects a simultaneously transmit-unavailable node and a simultaneously receive-unavailable node of each 1-hop node of the node using channel quality values of the 1-hop nodes of the node and a channel quality value of each 1-hop node of the 1-hop nodes of the node, excludes a transmission scheduled resource of a simultaneously transmit-unavailable node of a 1-hop nodes from a transmitting resource when allocating a transmitting resource of the node, and excludes a transmission scheduled resource of the simultaneously transmit-unavailable node of the simultaneously receive-unavailable node of a 1-hop node, which is a transmission target of the receiving node, from receivable resources of the node when allocating a receiving resource of the node.

The allocation controller may select a 1-hop node of a 1-hop node of the node in which a value that is a difference between a channel quality value of each 1-hop node of a 1-hop node of the node from a channel quality value of the 1-hop nodes of the node or a value that is a quotient of a channel quality value of a 1-hop node of the node and a channel quality value of each 1-hop node of the 1-hop node of the node is larger than a reference value as a simultaneously transmit-unavailable node of the 1-hop node of the node.

The allocation controller may select another hop node in which a value that is a difference between a channel quality value of another of each 1-hop node and a channel quality value of each 1-hop node of the node or a value that is a quotient of a channel quality value of each 1-hop node of the node and a channel quality value of another of each 1-hop node is larger than a reference value as a simultaneously receive-unavailable node of a reference 1-hop node.

### BRIEF DESCRIPTION OF THE DRAWINGS

FIG. 1 is a diagram illustrating an example of interference that may occur in a wireless mesh network.

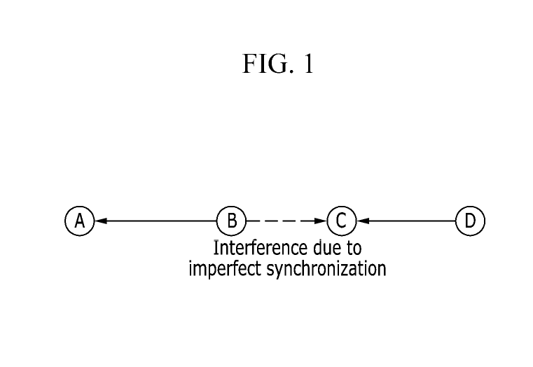

FIG. 2 is a diagram illustrating a wireless communication system according to an exemplary embodiment of the present invention.

FIG. 3 is a diagram illustrating resources in an OFDMA-based wireless mesh network system according to an exemplary embodiment of the present invention.

FIG. 4 is a flowchart illustrating a method of allocating a resource according to an exemplary embodiment of the present invention.

FIG. 5 is a diagram illustrating an example of interference occurrence due to imperfect synchronization in a wireless mesh network according to an exemplary embodiment of the present invention.

FIG. 6 is a flowchart illustrating a method of allocating a transmitting resource that can avoid interference due to imperfect synchronization in a transmitting node according to an exemplary embodiment of the present invention.

FIG. 7 is a diagram illustrating an example of a resource map of a node F in a wireless mesh network that is shown in FIG. 5.

FIG. 8 is a diagram illustrating an example of a resource map of a node D using a method of allocating a resource according to an exemplary embodiment of the present invention.

FIG. 9 is a flowchart illustrating a method of allocating a receiving resource that can avoid interference due to imperfect synchronization in a receiving node according to an exemplary embodiment of the present invention.

FIG. 10 is a diagram illustrating an example of a resource map of a node B in a wireless mesh network that is shown in FIG. 5.

FIG. 11 is a diagram illustrating an example of a resource map of a node C using a method of allocating a resource according to an exemplary embodiment of the present invention.

FIG. 12 is a diagram illustrating a resource allocation apparatus of a node according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a method and apparatus for allocating a resource for avoiding interference of a wireless communication system according to an exemplary embodiment of the present invention will be described in detail with reference to the drawings.

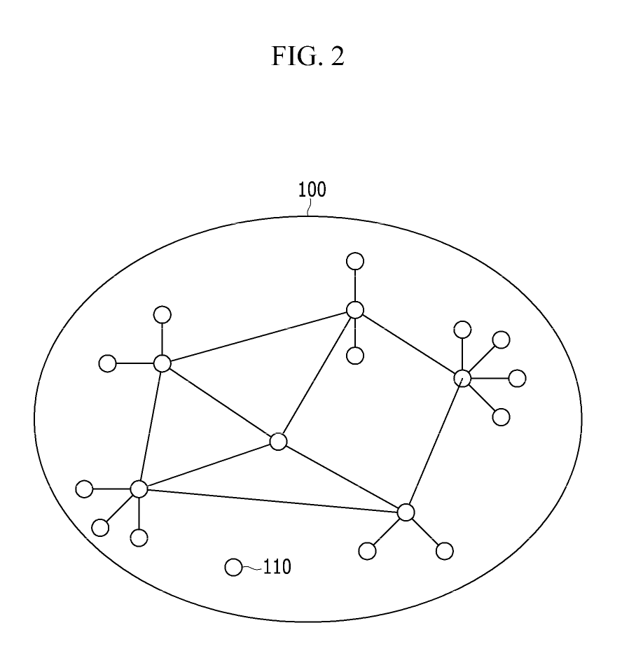

FIG. 2 is a diagram illustrating a wireless communication system according to an exemplary embodiment of the present invention.

Referring to FIG. 2, a wireless communication system represents, for example, a network system in which communication is performed between nodes forming a network like a wireless mesh network or a mobile ad-hoc network, and FIG. 2 illustrates a wireless mesh network system in which a plurality of nodes communicate through multi-hop as a wireless network system.

A wireless mesh network system 100 includes a plurality of nodes 110.

Each node 110 may be an access point that performs a function of a base station, and the node 110 may be a terminal. The node 110 performs wireless communication using an orthogonal frequency division multiple access (OFDMA) method.

The node 110 corresponding to a transmission subject selects a receiving node according to a transmission power arrival range (or other condition), and allocates a transmitting resource to use for transmission by exchanging resource information with a receiving node. Further, the node 110 corresponding to a receiving subject allocates a receiving resource to use for reception by exchanging resource information with a transmitting node.

When a transmitting resource and a receiving resource are being allocated, the node 110 selects an allocatable transmitting resource and an allocatable receiving resource using resource allocation information of an adjacent node, allocates a transmitting resource from the allocatable transmitting resource, and allocates a receiving resource from the allocatable receiving resource, thereby preventing resource collision with an adjacent node. Further, the node 110 allocates the transmitting resource and the receiving resource in order to avoid interference that may occur due to imperfect synchronization between adjacent nodes.

Here, an adjacent node may include a 1-hop node or a 2-hop node of the node 110. In general, a receivable adjacent node with arrival of transmission power of any one node 110 is defined as a 1-hop node of the node 110, and a node that does not overlap with the 1-hop of the node 110 among 1-hop nodes of the 1-hop node is defined as a 2-hop node of the node 110.

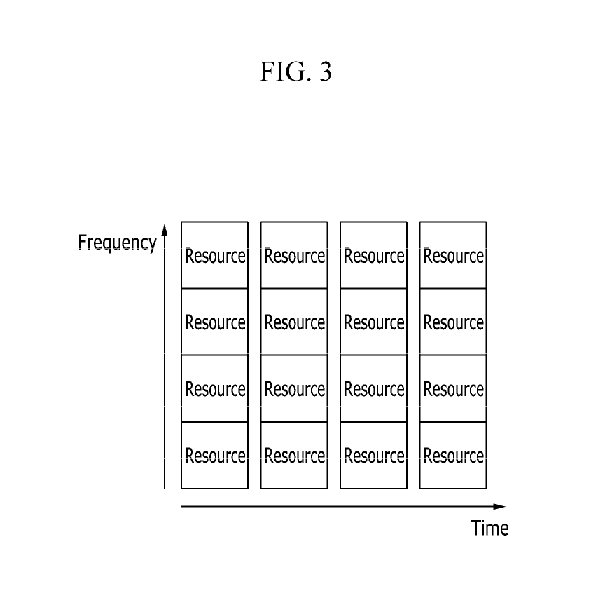

FIG. 3 is a diagram illustrating resources in an OFDMA-based wireless mesh network system according to an exemplary embodiment of the present invention.

Referring to FIG. 3, resources in an OFDMA-based wireless mesh network system are divided into a time axis and a frequency axis. Hereinafter, a time axis resource is referred to as a subframe, and a frequency axis resource is referred to as a subchannel.

That is, in an OFDMA-based wireless mesh network system, it is determined which subchannel of any subframe the node 110 allocates a resource of.

Because the node 110 can perform only transmission or reception within one subframe, the node 110 allocates one subframe as only a transmitting resource or a receiving resource using resource allocation information of an adjacent node. Further, because a random communication node can receive a signal from a plurality of 1-hop nodes through different subchannels within one subframe, the node 110 allocates a transmitting resource and a receiving resource in consideration of this. Further, the node 110 allocates a transmitting resource and a receiving resource in consideration of interference that may be generated due to imperfect synchronization with an adjacent node.

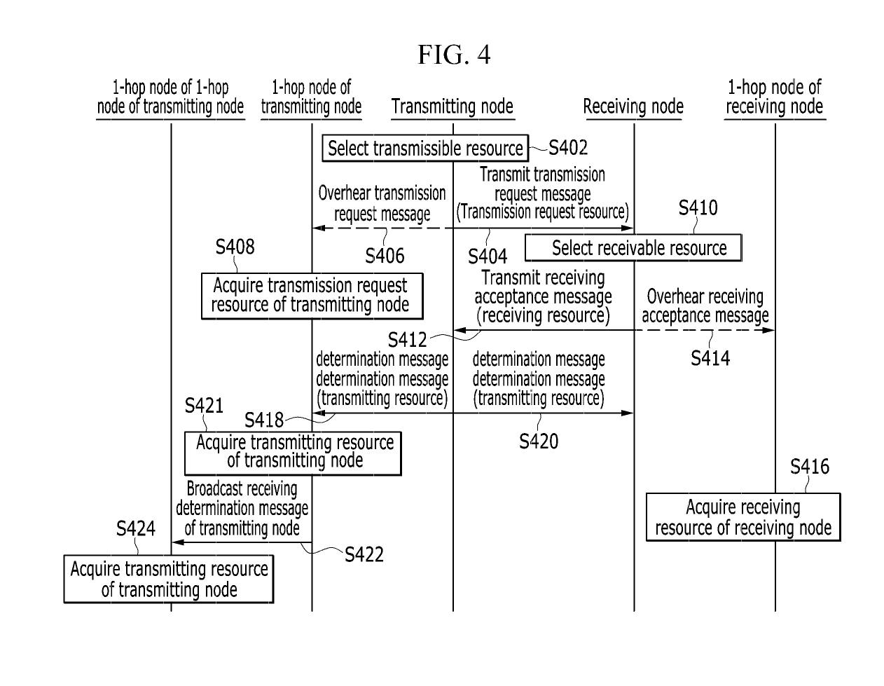

FIG. 4 is a flowchart illustrating a method of allocating a resource according to an exemplary embodiment of the present invention.

In FIG. 4, for convenience of description, a node is defined as a transmitting node, a receiving node, a 1-hop node of a transmitting node, a 1-hop node of a 1-hop node of a transmitting node, and a 1-hop node of a receiving node according to a function thereof. The 1-hop node of the receiving node corresponds to a 1-hop or a 2-hop node of the transmitting node.

Referring to FIG. 4, the transmitting node selects transmissible resources that does not undergo collision or influential interference with an adjacent node (S402), and allocates at least a portion of transmissible resources as a transmission request resource and transmits the transmission request resource to the receiving node through a transmission request message (S404). The transmission request message may include an identifier and a request of traffic amount of the receiving node as well as transmissible resources. The adjacent node may include a 1-hop node of a receiving node and of the transmitting node.

The 1-hop node of the transmitting node overhears a transmission request message (S406) and acquires transmission request resource information of the transmitting node (S408). The 1-hop node of the transmitting node does not allocate a transmission request resource that the transmitting node allocates as a receiving resource.

The receiving node selects receivable resources in which collision or influential interference does not occur with an adjacent node among transmission request resources (S410), and allocates at least a portion of receivable resources as a receiving resource and transmits the receiving resource to the transmitting node through a receiving acceptance message (S412). The receiving acceptance message may include an identifier of the transmitting node as well as receiving resource information.

The 1-hop node of the receiving node overhears a receiving acceptance message (S414), and acquires receiving resource information of the receiving node (S416).

In order to prevent collision with the receiving node, the 1-hop node of the receiving node, having acquired the receiving resource of the receiving node, does not allocate a receiving resource that the receiving node has allocated as a transmitting resource.

The transmitting node receives a receiving acceptance message and broadcasts a receiving determination message including transmitting resource information of the transmitting node identical to receiving resource information of the receiving node that is included in the receiving acceptance message to adjacent nodes (S418 and S420). Therefore, the 1-hop node of the transmitting node acquires transmitting resource information of the transmitting node (S421).

In order to prevent collision with the transmitting node, the 1-hop node of the transmitting node, having received the receiving determination message of the transmitting node, does not allocate a transmitting resource that the transmitting node allocates as a receiving resource. The 1-hop node of the transmitting node may again later include a resource that does not belong to a receiving resource that it acquires by overhearing the receiving acceptance message among transmission request resources that it acquires by overhearing a transmission request message in receivable resources.

The 1-hop node of the transmitting node, having received a receiving determination message from the transmitting node, broadcasts the receiving determination message of the transmitting node to a 1-hop node thereof, i.e., a 2-hop node of the transmitting node (S422). Thereafter, the 2-hop node of the transmitting node acquires transmitting resource information of the transmitting node (S424).

When a receiving node of the 2-hop node is the 1-hop node of the transmitting node, in order to prevent collision in the receiving node of the 2-hop node, the 2-hop node of the transmitting node, having received the receiving determination message of the transmitting node, does not allocate a transmitting resource that the transmitting resource allocates as a transmitting resource.

The transmitting node transmits data in the allocated transmitting resource to the receiving node through such a process, and the receiving node receives data without collision.

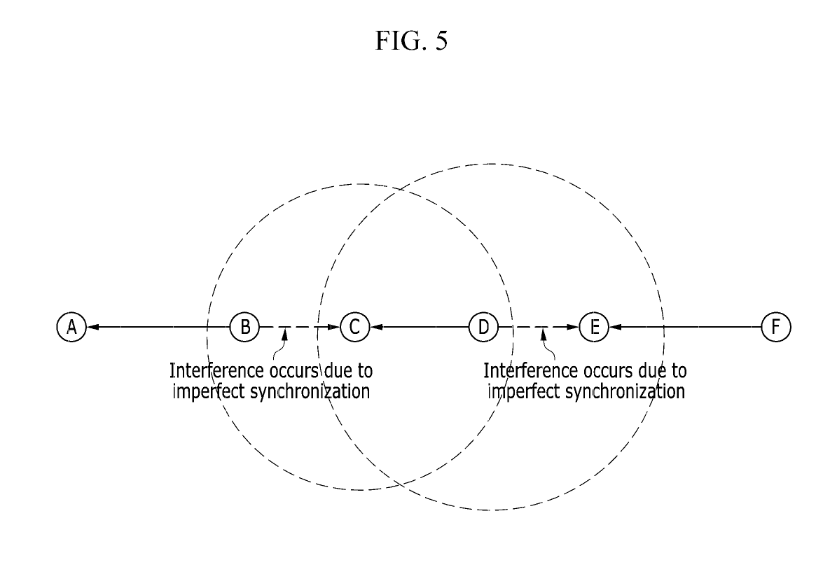

FIG. 5 is a diagram illustrating an example of interference occurrence due to imperfect synchronization in a wireless mesh network according to an exemplary embodiment of the present invention.

Referring to FIG. 5, 1-hop nodes of a node C are nodes B and D, and 1-hop nodes of the node D are nodes C and E. In this case, a distance between the node B and the node C and a distance between the node D and the node E is smaller than a distance between the node C and the node D.

In such a wireless mesh network, when the node B, which is a 1-hop node of the node C, transmits a signal of a large power level to a node A, which is a 1-hop node of the node B, the node C may receive a signal of the node D. When an offset exists between synchronization of the node C and the node D and synchronization of the node C and the node B and when the node B transmits a signal with high power to the node A of a far distance, in the node C, large transmission power of the node B may operate as large interference to a received signal from the node D. Therefore, even if a transmitting resource of the node B and a transmitting resource of the node D are different at the same transmission segment, interference due to imperfect synchronization of the node D and the node B reduces an SINR of a received signal from the node D and thus signal reception of the node C may fail.

Further, when the node E receives a signal of the node F, the node D may transmit a signal of a large power level to the node C. When an offset exists between synchronization of the node C and the node D and synchronization of the node D and the node E, and when the node E receives a signal of a low power level from the node F of a far distance, large transmission power of the node D may operate as large interference. Therefore, even if a transmitting resource of the node D and a transmitting resource of the node F are different at the same transmission segment, interference by imperfect synchronization of the node D and the node F reduces an SINR of a received signal from the node F and thus signal reception of the node E may fail.

Therefore, it is necessary that the transmitting node and the receiving node allocate a transmitting resource and a receiving resource in consideration of avoidance of interference due to imperfect synchronization with an adjacent node.

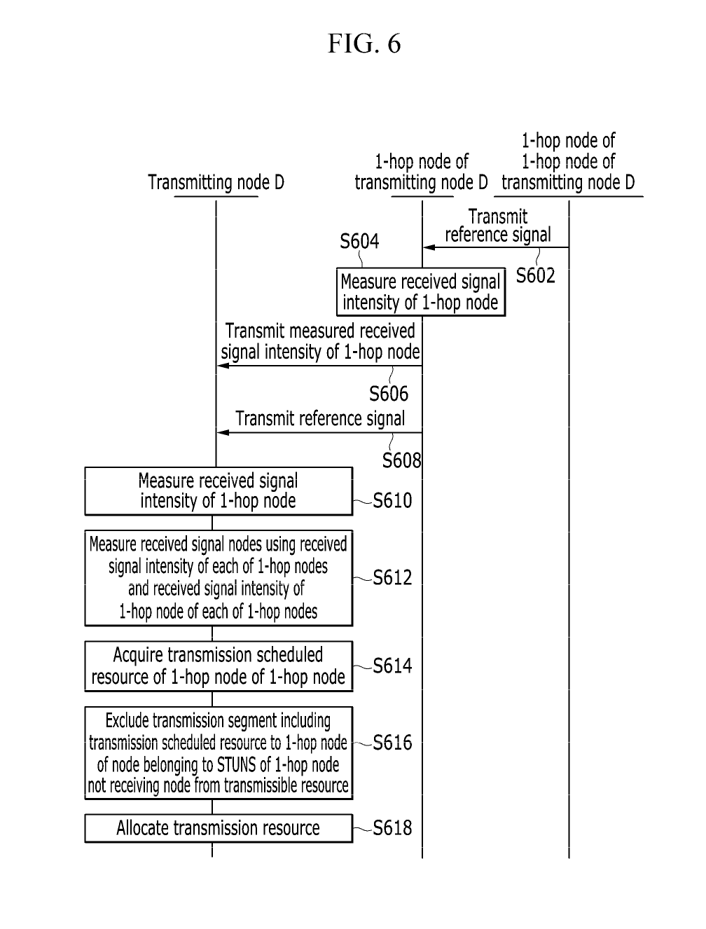

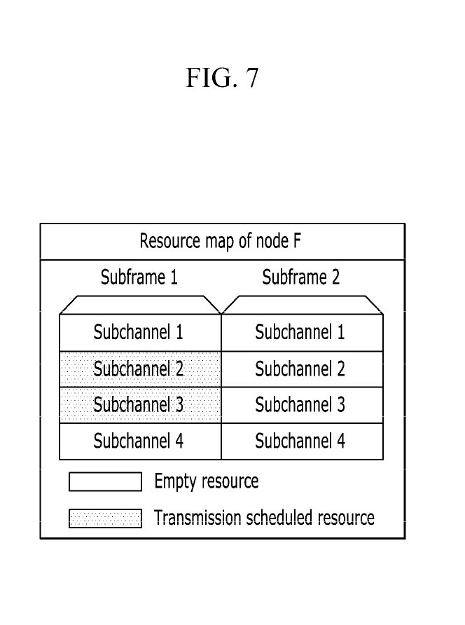

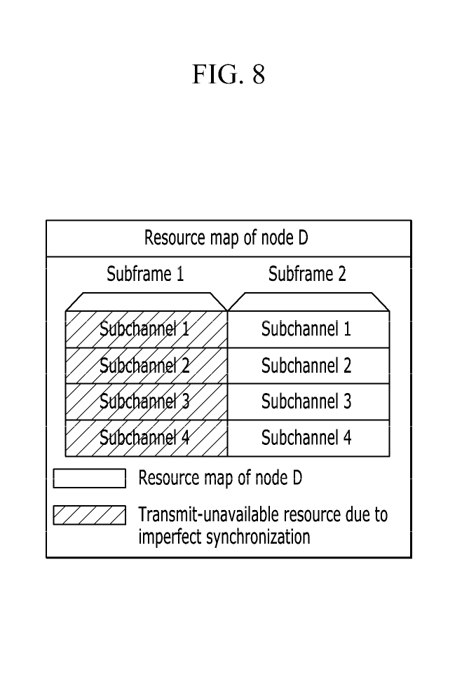

FIG. 6 is a flowchart illustrating a method of allocating a transmitting resource that can avoid interference due to imperfect synchronization in a transmitting node according to an exemplary embodiment of the present invention. FIG. 7 is a diagram illustrating an example of a resource map of a node F in a wireless mesh network that is shown in FIG. 5, and FIG. 8 is a diagram illustrating an example of a resource map of a node D using a method of allocating a resource according to an exemplary embodiment of the present invention.

Referring to FIG. 6, the transmitting node D periodically or quasi-periodically receives a channel quality value of 1-hop nodes B and F of the nodes C and E from each of the 1-hop nodes C and E that may become a receiving target. The channel quality value may include received signal strength (RSS), a signal-to-noise ratio (SNR), or a carrier-to-noise ratio (CNR), and hereinafter, for convenience of description, it is assumed that RSS is used as a channel quality value.

That is, each of the 1-hop nodes C and E that may become a receiving target receives a preamble that can distinguish a node or a reference signal such as a pilot signal for channel estimation of a resource that is allocated by transmission from the 1-hop nodes B and F of the nodes C and E (S602), and measures RSS of the 1-hop nodes B and F of the nodes C and E from a reference signal or a preamble that it receives from the 1-hop nodes B and F of the nodes C and E (S604).

Thereafter, the 1-hop nodes C and E transmit RSS of the 1-hop nodes B and F of the nodes C and E to the transmitting node D (S606). For example, when a 1-hop node that may be a receiving target of the transmitting node D is the node C, and a 1-hop node of the node C is the node B, the node C measures RSS of the 1-hop node of the node C and transmits the RSS to the transmitting node D.

The transmitting node D receives a preamble or a reference signal from each of the 1-hop nodes C and E (S608), and measures RSS of each of the 1-hop nodes C and E using the reference signal or the preamble that it receives from each of the 1-hop nodes C and E (S610).

The transmitting node D selects a simultaneously transmit-unavailable node set (STUNS) of each of the 1-hop nodes C and E using RSS of each of the 1-hop nodes C and E and RSS of the 1-hop nodes B and F of each of the 1-hop nodes C and E, that each of the 1-hop nodes C and E receives (S612).

When a value that is a difference between RSS (in a unit of dB or dBm) of the 1-hop nodes B and F of each of the 1-hop nodes C and E that it receives from each of the 1-hop nodes C and E and RSS of each of the 1-hop nodes C and E, or a value that is a quotient of RSS (in a linear unit) of each of the 1-hop nodes C and E and RSS of the 1-hop nodes B and F of each of the 1-hop nodes C and E that it receives from each of the 1-hop nodes C and E, is larger than a reference value, the transmitting node D adds the 1-hop node of the 1-hop nodes to STUNS of the 1-hop nodes C and E. For example, in the transmitting node D, when selecting STUNS of the 1-hop node E, the transmitting node D calculates a value that is a difference between RSS of 1-hop node F of the 1-hop node E that it receives from the 1-hop node E and RSS of the 1-hop node E, or a value that is a quotient of RSS of the 1-hop node E and RSS of a 1-hop node F of the 1-hop node E that it receives from the 1-hop node E. In this case, when the difference value or the quotient value is larger than a reference value, the transmitting node D adds the 1-hop node F of the 1-hop node E to STUNS of the 1-hop node E. That is, because a distance between the node E and the node F is smaller than that between the transmitting node D and the node E or a channel gain between the node E and the node F is larger than that between the transmitting node D and the node E, the node F is added to STUNS of the node E.

In this method, the transmitting node D selects a node belonging to STUNS of each of the 1-hop nodes C and E.

Here, the reference value may be determined by synchronization performance that is required in a system, such as an allowable time and frequency offset. When an allowable range of system request synchronization performance, i.e., a time and frequency offset, is large, interference power increases and thus a reference value has a relatively small value, and if an allowable range of system request synchronization performance, i.e., a time and frequency offset, are small, a reference value has a relatively large value.

The transmitting node D acquires transmission scheduled information to the nodes C and E of 1-hop nodes B and F of the nodes C and E from each of the 1-hop nodes C and E (S614). The transmission scheduled information includes transmitting resource information. Because receiving resource information that is included in a receiving acceptance message of the 1-hop nodes C and E of the transmitting node D, which is a receiving node of the 2-hop nodes B and F of the transmitting node D, is the same as transmitting resource information of the 2-hop nodes B and F of the transmitting node D, the transmitting node D overhears a receiving acceptance message of the 1-hop nodes C and E of the transmission node D and thus acquires transmission scheduled information of the 2-hop nodes B and F from receiving resources information that is included in the receiving acceptance message.

The transmitting node D excludes a transmission segment including a transmission scheduled resource to the 1-hop nodes C and E of the nodes B and F belonging to STUNS of the 1-hop nodes C and E, from transmissible resources (S616). Here, in OFDM or OFDMA transmission, the transmission scheduled resource may be a segment including a subchannel that is formed with a subcarrier or a plurality of subcarriers, and the transmission segment may be a segment including a subframe that is formed with an OFDM symbol or a plurality of OFDM symbols. For example, when a transmission scheduled resource map of the node F is formed, as shown in FIG. 7, the transmitting node D may select the remaining resources, except for a subframe 1 including a transmission scheduled resource of the node F, as transmissible resources, as shown in FIG. 8.

The transmitting node D allocates a transmitting resource using a method that is described in FIG. 4 in the transmissible resource (S618).

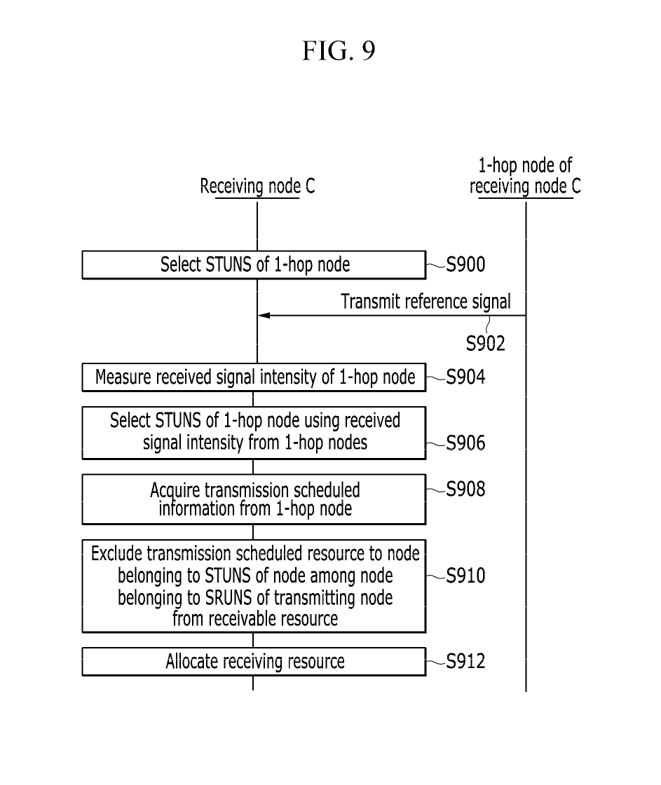

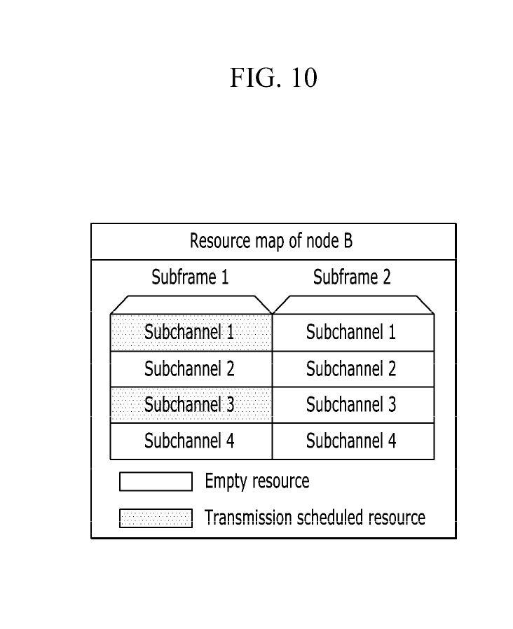

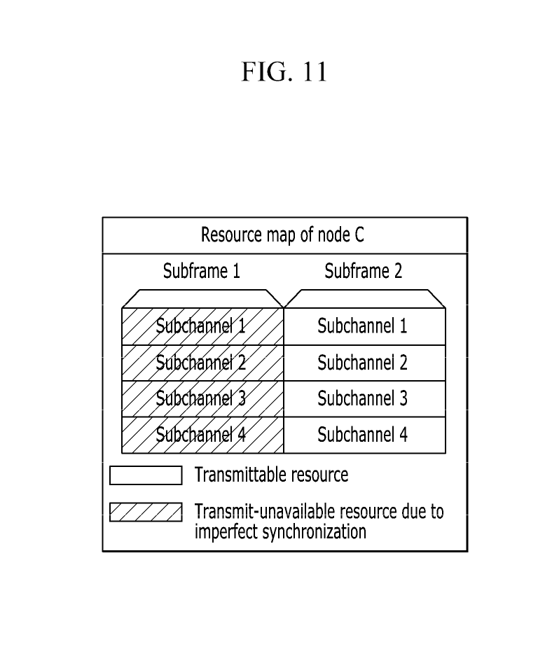

FIG. 9 is a flowchart illustrating a method of allocating a receiving resource that can avoid interference due to imperfect synchronization in a receiving node according to an exemplary embodiment of the present invention, FIG. 10 is a diagram illustrating an example of a resource map of a node B in a wireless mesh network that is shown in FIG. 5, and FIG. 11 is a diagram illustrating an example of a resource map of a node C using a method of allocating a resource according to an exemplary embodiment of the present invention.

Referring to FIG. 9, the receiving node C selects STUNS for each of the 1-hop nodes B and D of the receiving node C, similarly to the above-described method of obtaining STUNS of the transmitting node D (S900). For example, the node B transmits RSS of the node A of the node B to the node C, and the node C measures RSS of the node B, and because a value that is a difference between RSS of the node A of the node B and RSS of the node B or a value that is a quotient of RSS of the node B and RSS of the node A of the node B is larger than a reference value, the node A is selected as STUNS to the 1-hop node B of the receiving node C.

Further, the receiving node C selects a simultaneously receive-unavailable node set (SRUNS) of the 1-hop nodes B and D using RSS of the other 1-hop nodes D and B of 1-hop nodes B and D (S906). In this case, the receiving node C measures channel quality of each of the 1-hop nodes B and D from a reference signal such as preamble or pilot that it receives from the 1-hop nodes B and D (S902-S904). The channel quality value may include received signal strength (RSS), a signal-to-noise ratio (SNR), or a carrier-to-noise ratio (CNR), and hereinafter, for convenience of description, it is assumed that RSS is used as a channel quality value.

For example, when the receiving node C selects SRUNS of the 1-hop node D, the receiving node C may add the 1-hop node D in which a value that is a difference between RSS (in a unit of dB or dBm) of the 1-hop node D and RSS (in a linear unit) of the remaining 1-hop node B, except for the 1-hop node D of each of the 1-hop nodes B and D, or a value that is a quotient of RSS of the remaining 1-hop node B, except for the 1-hop node D, and RSS of the 1-hop node D is larger than a reference value to SRUNS of the 1-hop node D.

Here, the reference value is determined from system request synchronization performance, such as an allowable time and frequency offset. If an allowable range of a system request synchronization performance, i.e., a time and frequency offset, is large, interference power increases and thus the reference value has a relatively small value, and if an allowable range of system request synchronization performance, i.e., a time and frequency offset, is small, the reference value has a relatively large value.

The receiving node C acquires transmission scheduled information from each of the 1-hop nodes B and D (S908). When the 1-hop nodes B and D transmit a receiving determination message to the 1-hop nodes A and E, which are a receiving target of the nodes B and D, the receiving node C overhears a receiving determination message of the 1-hop nodes B and D and acquires transmission scheduled information of the 1-hop nodes B and D from transmitting resource information that is included in the receiving determination message.

The receiving node C excludes a transmission segment including a transmission scheduled resource to a node belonging to STUNS of the node B belonging to SRUNS of the transmitting node D from receivable resources (S910). That is, when the node B belonging to SRUNS of the transmitting node D transmits a signal to another node A belonging to STUNS of the node B, large transmission power of the node B may become large interference to the receiving node C. However, when the node B belonging to SRUNS of the transmitting node transmits a signal to a node that does not belong to STUNS of the node B, the node B transmits a signal with relatively low power and thus the receiving node C has no large interference. Therefore, the receiving node C excludes a transmission segment including a transmission scheduled resource to a node belonging to STUNS of the nodes among nodes belonging to SRUNS of the transmitting node D from receivable resources.

For example, when a transmission scheduled resource map of the node B belonging to SRUNS of the transmitting node D and being supposed to transmit a node belonging to STUNS of the node B is formed, as shown in FIG. 10, the receiving node C excludes a subframe 1 including a transmission scheduled resource of the node B from receivable resources, as shown in FIG. 11.

The receiving node C allocates a receiving resource using a method that is described in FIG. 4 in receivable resources in which a transmission segment including a transmission scheduled resource of the node B belonging to SRUNS of the transmitting node D is excluded (S912).

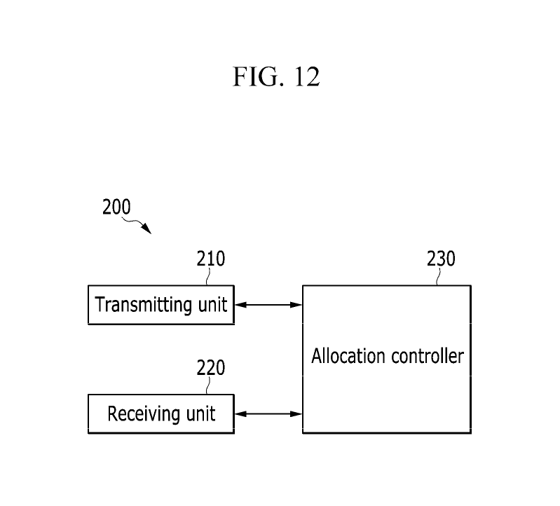

FIG. 12 is a diagram illustrating a resource allocation apparatus of a node according to an exemplary embodiment of the present invention.

Referring to FIG. 12, a resource allocation apparatus 200 of the node 110 includes a transmitting unit 210, a receiving unit 220, and an allocation controller 230.

The transmitting unit 210 transmits a resource allocation control message and data to an adjacent node, and the receiving unit 220 receives a resource allocation control message and data from an adjacent node. The resource allocation control message may include a transmission request message, a receiving acceptance message, and a receiving determination message that are described in FIG. 4. Further, a preamble or a reference signal may be transmitted together with the resource allocation control message.

The allocation controller 230 acquires resource scheduled information of an adjacent node of the node 110. The allocation controller 230 determines whether a 1-hop node of a 1-hop node of the node 110 satisfies an admission condition of STUNS of a 1-hop node of the node 110, and if a 1-hop node of a 1-hop node of the node 110 satisfies an admission condition of STUNS of a 1-hop node of the node 110, the allocation controller 230 adds a 1-hop node of a 1-hop node of the node 110 to STUNS of the 1-hop node.

Thereby, the allocation controller 230 selects STUNS of each 1-hop node and excludes a transmission segment including a transmission scheduled resource of a node belonging to STUNS of a 1-hop node, except for a receiving target from transmissible resources. Thereafter, the allocation controller 230 allocates a transmission request resource in the transmissible resource and allocates a transmitting resource using a method that is described in FIG. 4. Here, an admission condition to STUNS of a corresponding 1-hop node may include a condition in which a value that is a difference between RSS of a 1-hop node of a corresponding 1-hop node and RSS of a corresponding 1-hop node or a value that is a quotient of RSS of a corresponding 1-hop node and RSS of a 1-hop node of a corresponding 1-hop node is larger than a reference value, as shown in FIG. 6.

Further, the allocation controller 230 determines whether another 1-hop node of the node 110 satisfies an admission condition of SRUNS with respect to a 1-hop node of the node 110, and if another 1-hop node of the node 110 satisfies an admission condition of SRUNS, the allocation controller 230 adds another 1-hop node satisfying an admission condition of SRUNS of a corresponding 1-hop node of the node 110 to SRUNS of a corresponding 1-hop node of the node 110. Thereby, the allocation controller 230 selects SRUNS of each 1-hop node and excludes a transmission segment including a transmission scheduled resource to a node belonging to STUNS of a node belonging to SRUNS of a 1-hop node corresponding to a receiving subject from receivable resources. Thereafter, the allocation controller 230 allocates a receiving resource in receivable resources. Here, an admission condition to SRUNS of a 1-hop node includes a condition in which a value that is a difference between RSS of a 1-hop node to be a reference and RSS of the remaining 1-hop node, except for a 1-hop node to be a reference of a 1-hop node, or a value that is a quotient of RSS of the remaining 1-hop node, except for a 1-hop node to be a reference of a 1-hop node, and RSS of a 1-hop node to be a reference, is larger than a reference value, as described in FIG. 10.

When the allocation controller 230 allocates a transmitting resource and a receiving resource with such a method, interference occurrence due to imperfect synchronization with each adjacent node can be prevented.

According to an exemplary embodiment of the present invention, in a wireless mesh network, when any one node receives signals of a plurality of adjacent nodes through different resources at the same time, the node compares received signal strength (RSS), signal-to-noise ratios (SNR), or carrier-to-noise ratios (CNR) from adjacent nodes and allocates a resource to prevent simultaneously transmitting to node pairs in which a compared difference is larger than a reference value, whereby interference is avoided due to imperfect synchronization with adjacent nodes at a receiving node, reliability of a link can be thus improved, and throughput of a network can increase.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method in which a transmitting node allocates a resource for avoiding interference in a wireless communication system, the method comprising:
selecting a simultaneously transmit-unavailable node of each 1-hop node of the transmitting node among 1-hop nodes of 1-hop nodes of the transmitting node;
acquiring a transmission scheduled resource of 1-hop nodes of the transmitting node and 1-hop nodes of 1-hop nodes of the transmitting node;
excluding a transmission scheduled resource of a simultaneously transmit-unavailable node of a 1-hop node of the transmitting node from transmissible resources of the transmitting node; and
allocating a transmitting resource in the transmissible resources.

2. The method of claim 1, wherein the selecting comprises:
calculating values that are differences between a channel quality value of each 1-hop node of the 1-hop nodes of the transmitting node and channel quality values of the 1-hop nodes of the transmitting node or values that are quotients of channel quality values of the 1-hop nodes of the transmitting node and a channel quality value of each 1-hop node of the 1-hop nodes of the transmitting node; and
selecting a 1-hop node of a 1-hop node of the transmitting node in which the difference value or the quotient value is larger than a reference value as a simultaneously transmit-unavailable node of the 1-hop nodes of the transmitting node.

3. The method of claim 2, wherein the calculating comprises:
measuring channel quality values of the 1-hop nodes of the transmitting node; and
receiving channel quality values of the 1-hop nodes of the 1-hop nodes of the transmitting node from the 1-hop nodes of the transmitting node.

4. The method of claim 3, wherein the calculating further comprises:
receiving reference signals from the 1-hop nodes; and
measuring channel quality values of the 1-hop nodes from the reference signals.

5. The method of claim 1, wherein the acquiring comprises:
overhearing, when 1-hop nodes of the transmitting node transmit resource allocation control messages comprising receiving resource information to another node, resource allocation control messages of the 1-hop nodes of the transmitting node; and
acquiring transmission scheduled resources of the 1-hop nodes of the 1-hop nodes of the transmitting node using the 1-hop nodes of the transmitting node as a receiving target through receiving resource information that is comprised in resource allocation control messages of the 1-hop nodes of the transmitting node.

6. The method of claim 1, wherein the resource comprises subframes of a time axis and subchannels of a frequency axis, and
wherein the excluding of a transmission scheduled resource comprises excluding a subframe comprising a subchannel corresponding to a transmission scheduled resource of the simultaneously transmit-unavailable node from transmissible resources of the transmitting node.

7. A method in which a receiving node allocates a resource for avoiding interference in a wireless communication system, the method comprising:
selecting a simultaneously transmit-unavailable node of each 1-hop node of the receiving node among 1-hop nodes of the receiving node;
selecting a simultaneously receive-unavailable node of each 1-hop node of the receiving node among the 1-hop nodes of the receiving node;
acquiring transmission scheduled resources of the 1-hop nodes of the receiving node;
excluding a transmission scheduled resource to a simultaneously transmit-unavailable node of a simultaneously receive-unavailable node of the 1-hop node, which is a transmission target of the receiving node, from receivable resources of the receiving node; and
allocating a receiving resource in the receivable resources.

8. The method of claim 7, wherein the selecting of a simultaneously transmit-unavailable node comprises:
calculating values that are differences between a channel quality value of another 1-hop node of each 1-hop node and a channel quality value of each 1-hop node of the transmitting node or values that are quotients of channel quality values of the 1-hop nodes of each 1-hop node of the receiving node and a channel quality value of another 1-hop node of each 1-hop node; and
selecting, if the difference value or the quotient value is larger than a reference value, the other 1-hop node of the 1-hop nodes as a simultaneously receive-unavailable node of the 1-hop nodes.

9. The method of claim 8, wherein the calculating of values comprise:
receiving reference signals from the 1-hop nodes of the receiving node; and
measuring channel quality values of the 1-hop nodes of the receiving node from the reference signals.

10. The method of claim 7, wherein the selecting of a simultaneously transmit-unavailable node comprises:
calculating values that are differences between a channel quality value of each 1-hop node of a 1-hop node of the receiving node and channel quality values of the 1-hop nodes of the receiving node or values that are quotients of channel quality values of the 1-hop nodes of the receiving node and a channel quality value of each 1-hop node of the 1-hop node of the receiving node; and
selecting a 1-hop node of a 1-hop node of a receiving node in which the difference value or the quotient value is larger than a reference value as a simultaneously transmit-unavailable node of the 1-hop nodes of the receiving node.

11. The method of claim 10, wherein the calculating of values comprise:
receiving, by 1-hop nodes of the receiving node, reference signals of the 1-hop nodes of the 1-hop nodes of the receiving node;
measuring, by the 1-hop nodes of the receiving node, channel quality values of the 1-hop nodes of the 1-hop node of the receiving node from the reference signals; and
receiving channel quality values of the 1-hop nodes of the 1-hop nodes of the receiving node in which the 1-hop nodes of the receiving node measures.

12. The method of claim 7, wherein the acquiring of transmission scheduled resources comprises:
overhearing, when 1-hop nodes of the receiving node transmit resource allocation control messages comprising transmitting resource information to another node, the resource allocation control messages of the 1-hop nodes of the receiving node; and
acquiring transmission scheduled resources of the 1-hop nodes of the receiving node through transmitting resource information that are comprised in receiving determination messages of the 1-hop nodes of the receiving node.

13. The method of claim 7, wherein the resource comprises subframes of a time axis and subchannels of a frequency axis, and
wherein the excluding of a transmission scheduled resource comprises excluding a subframe comprising a subchannel corresponding to a transmission scheduled resource to a simultaneously transmit-unavailable node of the simultaneously receive-unavailable node from the receivable resource of the receiving node.

14. An apparatus that allocates a resource for avoiding interference in a node of a wireless communication system, the apparatus comprising:
a receiver that receives a control message from 1-hop nodes of the node; and
an allocation controller that acquires a transmission scheduled resource of 1-hop nodes of the 1-hop nodes and a transmission scheduled resource of the 1-hop node through the control message, that selects a simultaneously transmit-unavailable node and a simultaneously receive-unavailable node of each 1-hop node of the node using channel quality values of the 1-hop nodes of the node and a channel quality value of each 1-hop node of the 1-hop nodes of the node, that excludes a transmission scheduled resource of a simultaneously transmit-unavailable node of 1-hop nodes from a transmitting resource when allocating a transmitting resource of the node, and that excludes a transmission scheduled resource of a simultaneously transmit-unavailable node of the simultaneously receive-unavailable node of a 1-hop node, which is a transmission target of the receiving node, from receivable resources of the node when allocating a receiving resource of the node.

15. The apparatus of claim 14, wherein the allocation controller selects a 1-hop node of a 1-hop node of the node in which values that are differences between a channel quality value of each 1-hop node of 1-hop nodes of the node and channel quality values of the 1-hop nodes of the node or values that are quotients of channel quality values of the 1-hop nodes of the node and a channel quality value of each 1-hop node of the 1-hop nodes of the node is larger than a reference value as a simultaneously transmit-unavailable node of the 1-hop nodes of the node.

16. The apparatus of claim 14, wherein the allocation controller selects another hop node in which values that are differences between a channel quality value of another of each 1-hop node from a channel quality value of each 1-hop node of the node or values that are quotients of a channel quality value of each 1-hop node of the node and a channel quality value of another of each 1-hop node is larger than a reference value as a simultaneously receive-unavailable node of the each 1-hop node.

17. The apparatus of claim 14, wherein the resource comprises subframes of a time axis and subchannels of a frequency axis, and
wherein the allocation controller excludes a subframe comprising a subchannel corresponding to a transmission scheduled resource of the simultaneously transmit-unavailable node from the transmitting resource and excludes a subframe comprising a subchannel corresponding to a transmission scheduled resource to a simultaneously transmit-unavailable node of the simultaneously receive-unavailable node from the receiving resource.

18. The apparatus of claim 14, wherein the allocation controller acquires transmission scheduled resources of 1-hop nodes of the 1-hop nodes using the 1-hop nodes as a receiving node by overhearing a receiving resource allocation control message of the 1-hop nodes and acquires a transmission scheduled resource of the 1-hop nodes by overhearing a transmission resource allocation control message of the 1-hop node.

19. The apparatus of claim 14, wherein the allocation controller measure channel quality values of the 1-hop nodes of the node and receive channel quality values of 1-hop nodes of the 1-hop nodes of the node in which the 1-hop nodes of the node measures from the 1-hop nodes of the node.

20. The apparatus of claim 14, wherein the channel quality values comprise at least one of received signal intensity, a signal-to-noise ratio, and a carrier-to-noise ratio.
